(19) United States
(12) Patent Application Publication
(10) Pub. No.: US 2010/0212108 A1
(43) Pub. Date: Aug. 26, 2010

(54) Castor Having Reinforced Strength

(76) Inventors: Sung-Wang Yang, Tainan Hsien (TW); Ming-Hsien Lin, Yongkang City (TW); Po-Lu Chen, Yongkang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/391,423

(22) Filed: Feb. 24, 2009

(51) Int. Cl. B60B 33/00

(52) U.S. Cl. 16/45; 16/29

(57) ABSTRACT

A castor includes an upright support tube, a mounting unit rotatably mounted on a lower end of the support tube, and a support bracket secured on the mounting unit. The mounting unit includes an upright hollow mounting post mounted on the support bracket and inserted into the support tube and a plurality of reinforcing plates mounted in the mounting post to reinforce a radial strength of the mounting post. The mounting post of the mounting unit has an outer wall provided with a plurality of radially and outwardly extending bushings abutting the inner wall of the support tube to reduce a friction between the mounting post and the support tube so as to facilitate rotation of the mounting post relative to the support tube.

### BACKGROUND OF THE INVENTION

1. Field of the Invention

The present invention relates to a castor and, more particularly, to a castor for a chair.

2. Description of the Related Art

A conventional castor comprises a mounting tube, a castor body swivelably mounted on a lower portion of the mounting tube, and a roller rotatably mounted on the castor body. The castor body has an upper portion provided with an insert inserted into the lower portion of the mounting tube to attach the castor body to the mounting tube. The lower portion of the mounting tube has a first protrusion, and the insert of the castor body has a second protrusion snapped onto the first protrusion of the mounting tube. However, the insert of the castor body has a hollow inside to decrease the strength of the castor body. In addition, the insert of the castor body cannot be mounted on the mounting tube easily and quickly, thereby causing inconvenience in assembly of the castor.

### BRIEF SUMMARY OF THE INVENTION

In accordance with the present invention, there is provided a castor, comprising an upright support tube, a mounting unit rotatably mounted on a lower end of the support tube, and a support bracket secured on the mounting unit. The mounting unit includes an upright hollow mounting post mounted on the support bracket and inserted into the support tube and a plurality of reinforcing plates mounted in the mounting post to reinforce a radial strength of the mounting post.

The primary objective of the present invention is to provide a castor having a reinforced strength.

Another objective of the present invention is to provide a castor, wherein the mounting unit includes a plurality of reinforcing plates mounted in the mounting post to reinforce the radial strength of the mounting post.

A further objective of the present invention is to provide a castor, wherein the mounting post of the mounting unit has an outer wall provided with a plurality of radially and outwardly extending bushings abutting the inner wall of the support tube to reduce a friction between the mounting post of the mounting unit and the support tube so as to facilitate rotation of the mounting post of the mounting unit relative to the support tube.

A further objective of the present invention is to provide a castor, wherein the mounting post of the mounting unit has an upper portion provided with two radially opposite elongate slits to make the upper portion of the mounting post flexible so as to facilitate mounting of the mounting post of the mounting unit into the support tube.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a castor in accordance with the preferred embodiment of the present invention.

FIG. 2 is a partially perspective view of the castor as shown in FIG. 1.

FIG. 3 is a partially perspective view of the castor as shown in FIG. 1.

FIG. 4 is a side cross-sectional view of the castor as shown in FIG. 1.

### DETAILED DESCRIPTION OF THE INVENTION

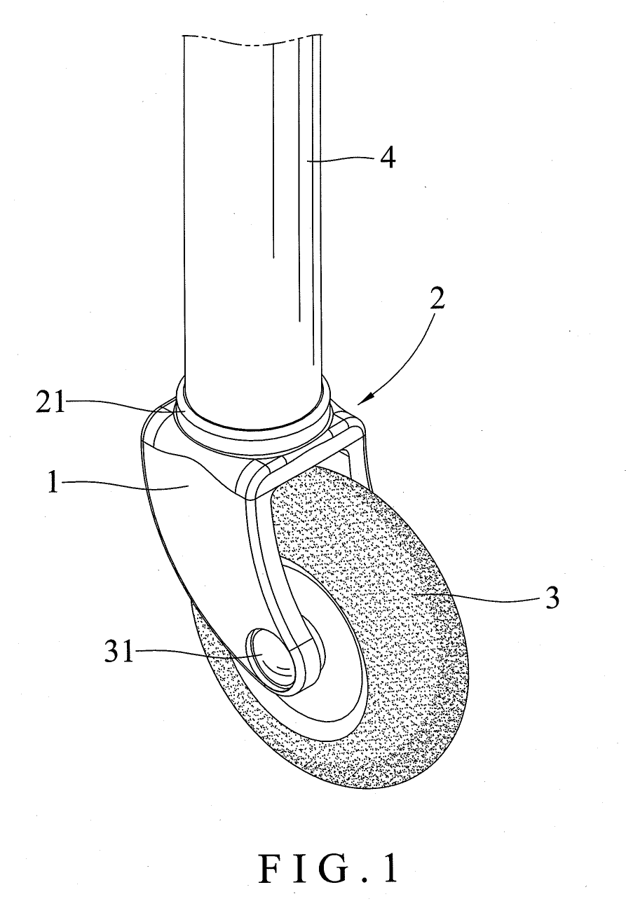

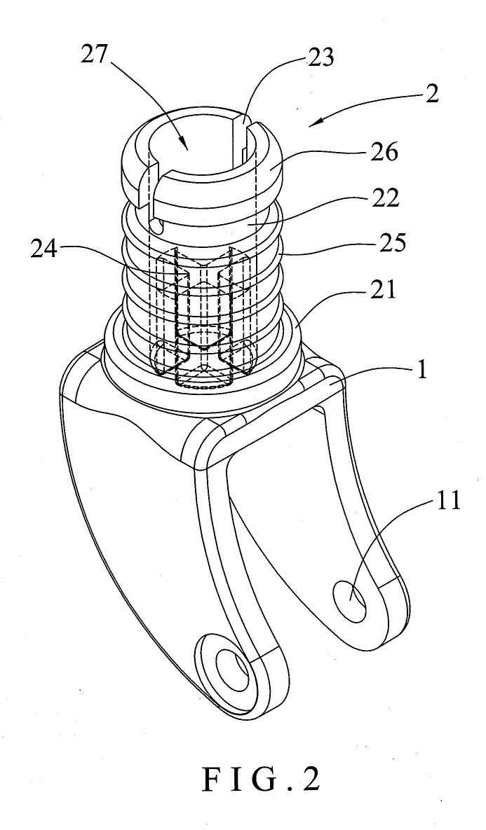

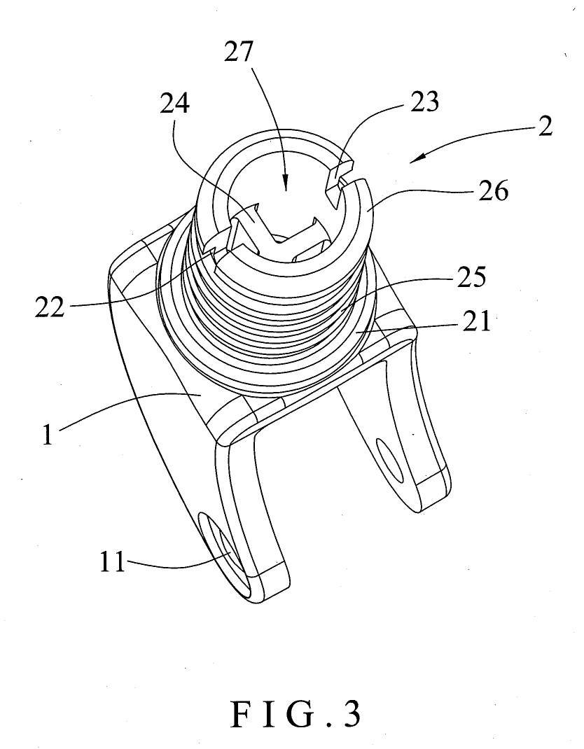

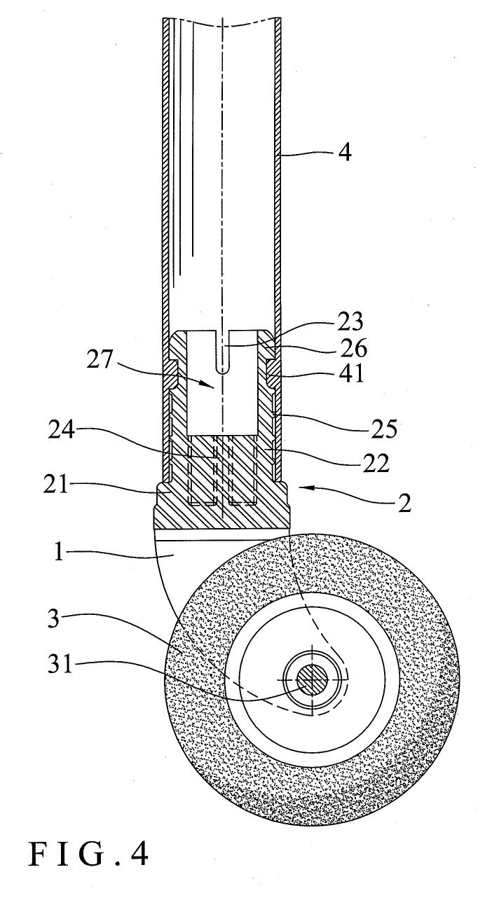

Referring to the drawings and initially to FIGS. 1-4, a castor in accordance with the preferred embodiment of the present invention comprises an upright support tube 4, a mounting unit 2 rotatably mounted on a lower end of the support tube 4, a support bracket 1 secured on the mounting unit 2, a roller 3 rotatably mounted on the support bracket 1, and a shaft 31 extending through the support bracket 1 and the roller 3 so that the roller 3 is rotatable on the shaft 31.

The support tube 4 has an inner wall provided with a radially and inwardly extending limit flange 41.

The mounting unit 2 includes an upright hollow mounting post 22 mounted on the support bracket 1 and inserted into the support tube 4, and a plurality of reinforcing plates 24 mounted in the mounting post 22 to reinforce a radial strength of the mounting post 22.

The mounting post 22 of the mounting unit 2 is integrally formed on and extends upward from a top of the support bracket 1. The mounting post 22 of the mounting unit 2 has a substantially tubular cross-sectional profile and has an inner portion provided with a receiving chamber 27 to receive the reinforcing plates 24. The receiving chamber 27 of the mounting post 22 extends into the top of the support bracket 1. The mounting post 22 of the mounting unit 2 has a top provided with a radially and outwardly extending retaining ring 26 abutting the limit flange 41 of the support tube 4 to limit the mounting post 22 of the mounting unit 2 in the support tube 4.

The mounting post 22 of the mounting unit 2 has an upper portion provided with two radially opposite elongate slits 23 to make the upper portion of the mounting post 22 flexible. The two elongate slits 23 of the mounting post 22 traverse the retaining ring 26 and are connected to the receiving chamber 27. The mounting post 22 of the mounting unit 2 has a lower portion provided with an enlarged shoulder 21 abutting a lower end of the support tube 4. The shoulder 21 of the mounting post 22 is integrally formed on and extends upward from the top of the support bracket 1.

The mounting post 22 of the mounting unit 2 has an outer wall provided with a plurality of radially and outwardly extending bushings 25 abutting the inner wall of the support tube 4 to reduce a friction between the mounting post 22 of the mounting unit 2 and the support tube 4 so as to facilitate rotation of the mounting post 22 of the mounting unit 2 relative to the support tube 4. The bushings 25 of the mounting post 22 are disposed between the retaining ring 26 and the shoulder 21, and the limit flange 41 of the support tube 4 is located between the retaining ring 26 and an uppermost one of the bushings 25 of the mounting post 22.

The reinforcing plates 24 of the mounting unit 2 are located in the receiving chamber 27 of the mounting post 22 and extends to a position in alignment with the shoulder 21 of the mounting post 22 and the lower end of the support tube 4. The reinforcing plates 24 of the mounting unit 2 are arranged in a radiating manner to form a substantially cruciform profile. The reinforcing plates 24 of the mounting unit 2 are located under the two elongate slits 23 of the mounting post 22.

The support bracket 1 has a substantially inverted U-shaped profile and has two opposite sides each provided with a through hole 11 to allow passage of the shaft 31.

In assembly, the mounting post 22 of the mounting unit 2 is inserted into the support tube 4 until the retaining ring 26 of the mounting post 22 touches the limit flange 41 of the support tube 4. At this time, when the retaining ring 26 of the mounting post 22 is pressed by the limit flange 41 of the support tube 4, the mounting post 22 of the mounting unit 2 is compressed and contracted radially and inwardly by provision of the two elongate slits 23 of the mounting post 22 so that the retaining ring 26 of the mounting post 22 is retracted radially and inwardly to pass by the limit flange 41 of the support tube 4. After the retaining ring 26 of the mounting post 22 passes by the limit flange 41 of the support tube 4, the mounting post 22 of the mounting unit 2 is expanded radially and outwardly by its restoring force, and the retaining ring 26 of the mounting post 22 is moved radially and outwardly to abut the limit flange 41 of the support tube 4 to limit the mounting post 22 of the mounting unit 2 in the support tube 4.

Accordingly, the mounting unit 2 includes a plurality of reinforcing plates 24 mounted in the mounting post 22 to reinforce the radial strength of the mounting post 22. In addition, the mounting post 22 of the mounting unit 2 has an outer wall provided with a plurality of radially and outwardly extending bushings 25 abutting the inner wall of the support tube 4 to reduce a friction between the mounting post 22 of the mounting unit 2 and the support tube 4 so as to facilitate rotation of the mounting post 22 of the mounting unit 2 relative to the support tube 4. Further, the mounting post 22 of the mounting unit 2 has an upper portion provided with two radially opposite elongate slits 23 to make the upper portion of the mounting post 22 flexible so as to facilitate mounting of the mounting post 22 of the mounting unit 2 into the support tube 4.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor, comprising:
an upright support tube;
a mounting unit rotatably mounted on a lower end of the support tube;
a support bracket secured on the mounting unit;
wherein the mounting unit includes:
an upright hollow mounting post mounted on the support bracket and inserted into the support tube;
a plurality of reinforcing plates mounted in the mounting post to reinforce a radial strength of the mounting post.

2. The castor of claim 1, wherein
the support tube has an inner wall provided with a radially and inwardly extending limit flange;
the mounting post of the mounting unit has a top provided with a radially and outwardly extending retaining ring abutting the limit flange of the support tube to limit the mounting post of the mounting unit in the support tube.

3. The castor of claim 2, wherein the mounting post of the mounting unit has an outer wall provided with a plurality of radially and outwardly extending bushings abutting the inner wall of the support tube to reduce a friction between the mounting post of the mounting unit and the support tube so as to facilitate rotation of the mounting post of the mounting unit relative to the support tube.

4. The castor of claim 3, wherein the mounting post of the mounting unit has a lower portion provided with an enlarged shoulder abutting a lower end of the support tube.

5. The castor of claim 4, wherein the bushings of the mounting post are disposed between the retaining ring and the shoulder.

6. The castor of claim 4, wherein the shoulder of the mounting post is integrally formed on and extends upward from a top of the support bracket.

7. The castor of claim 3, wherein the limit flange of the support tube is located between the retaining ring and an uppermost one of the bushings of the mounting post.

8. The castor of claim 2, wherein the mounting post of the mounting unit has an inner portion provided with a receiving chamber to receive the reinforcing plates.

9. The castor of claim 8, wherein the reinforcing plates of the mounting unit are located in the receiving chamber of the mounting post.

10. The castor of claim 4, wherein the reinforcing plates of the mounting unit extends to a position in alignment with the shoulder of the mounting post and the lower end of the support tube.

11. The castor of claim 1, wherein the reinforcing plates of the mounting unit are arranged in a radiating manner to form a substantially cruciform profile.

12. The castor of claim 8, wherein the mounting post of the mounting unit has an upper portion provided with two radially opposite elongate slits to make the upper portion of the mounting post flexible.

13. The castor of claim 12, wherein the reinforcing plates of the mounting unit are located under the two elongate slits of the mounting post.

14. The castor of claim 12, wherein the two elongate slits of the mounting post are connected to the receiving chamber.

15. The castor of claim 1, wherein the two elongate slits of the mounting post traverse the retaining ring.

16. The castor of claim 1, wherein the mounting post of the mounting unit is integrally formed on and extends upward from a top of the support bracket.

17. The castor of claim 8, wherein the mounting post of the mounting unit has a substantially tubular cross-sectional profile.

18. The castor of claim 8, wherein the receiving chamber of the mounting post extends into a top of the support bracket.

19. The castor of claim 1, further comprising:
a roller rotatably mounted on the support bracket;
a shaft extending through the support bracket and the roller so that the roller is rotatable on the shaft.

20. The castor of claim 19, wherein the support bracket has a substantially inverted U-shaped profile and has two opposite sides each provided with a through hole to allow passage of the shaft.
